(19) United States
(12) Patent Application Publication
(10) Pub. No.: US 2024/0263674 A1
(43) Pub. Date: Aug. 8, 2024

(54) BOOT ASSEMBLY OF DRIVE AXLE

(71) Applicant: HYUNDAI WIA Corporation, Changwon-si, Gyeongsangnam-do (KR)

(72) Inventors: Chang Hee Jeong, Yongin-si, Gyeonggi-do (KR); Hee Joon Kim, Incheon (KR); Bum Jae LEE, Yongin-si, Gyeonggi-do (KR)

(21) Appl. No.: 18/567,723

(22) PCT Filed: Jun. 10, 2022
(86) PCT No.: PCT/KR2022/008230

§ 371 Date: Dec. 6, 2023

(30) Foreign Application Priority Data
Oct. 6, 2021 (KR) 10-2021-0075371

(51) Int. Cl. F16D 3/84; F16C 33/78; F16D 3/226

(52) U.S. Cl. CPC F16D 3/845; F16C 33/78; F16D 3/2265; F16C 2326/02; F16D 2300/08; F16D 2300/18

(57) ABSTRACT

The present invention relates to a boot assembly of a drive axle in which a bearing seal of a wheel bearing is removed to reduce drag torque and also reduce friction noise occurring in a wrinkled portion of the boot, and introduces a boot assembly of a drive axle configured to include: a wheel bearing assembled to a wheel housing; an outer ring formed in a ring shape and having an outer diameter part fixed to an outer wheel of the wheel bearing; a boot having a large diameter part of one end thereof, assembled to an inner diameter part of the outer ring; and a bearing seal unit assembled between a small diameter part of the other end thereof and a driveshaft by a band to prevent the introduction of foreign matter while restricting the rotation of the boot.

### TECHNICAL FIELD

The present disclosure relates to a drive axle assembly that reduces drag torque, improves fuel efficiency of a vehicle and decrease friction noise that is generated at wrinkled portions of a boot because the bearing inner seal of a wheel bearing is removed.

### BACKGROUND ART

An Integrated Drive Axle (IDA) is a structure formed by integrating the outer race of a driveshaft and the hub of a wheel bearing.

That is, the functions of a wheel bearing and a driveshaft are integrated, so there is the advantage that not only the weight, but the cost of a product are reduced, the tilt angle of the driveshaft is increased by a decrease of a joint center distance, and the lateral stiffness of a vehicle is increased by an increase of the PCD of the wheel bearing.

However, an increase in size of a wheel bearing acts as a factor that increases drag torque of the wheel bearing, which results in a bad influence on the fuel efficiency of a vehicle.

Accordingly, it is possible to reduce drag torque of a wheel bearing by changing the structure of a bearing inner seal that is in charge of the sealability of the wheel bearing.

However, since the bearing inner seal fitted between the outer race and the inner race of a wheel bearing is exposed outside a boot, it is required to maintain the sealing ability of the bearing inner seal over a predetermined level in order to prevent foreign substance from entering the wheel bearing.

However, the higher the sealing ability of a bearing inner seal, the larger the drag torque is, so there is limitation in reducing drag torque.

That is, since a bearing inner seal is fitted between an inner race and an outer race, the circumference of the bearing inner seal becomes relatively long, so there is a defect that drag torque is increased due to sealing by the bearing inner seal.

Further, since a boot is rotated with a constant velocity joint, the wrinkles of the boot are continuously circumferentially folded and unfolded in full turning, and in this process, soil/de-icer, etc. repeatedly adhere to or come off the insides of the wrinkles of the boot through contact with moisture, so there is a problem that friction noise is generated.

The description provided above as a related art of the present disclosure is just for helping understand the background of the present disclosure and should not be construed as being included in the related art known by those skilled in the art.

In relation to this matter, there are JP 5868643 B2 and JP 2007-315423 A in the related art.

### DETAILED DESCRIPTION

### Technical Tasks

The present disclosure has been made in an effort to solve the problems described above and an objective of the present disclosure is to provide a drive axle assembly that reduces drag torque and improves fuel efficiency of a vehicle because the bearing inner seal of a wheel bearing is removed.

Another objective of the present disclosure is to provide a drive axle assembly configured to reduce friction noise that is generated at wrinkled portions of a boot.

### Technical Solution

A configuration of the present disclosure for achieving the objectives described above provides a boot assembly of a drive axle, the boot assembly including: a wheel bearing assembled to a wheel housing; an outer ring formed in a ring shape and having an outer part fixed to an outer race of the wheel bearing; a boot having a large-diameter section at a first end assembled to an inner part of the outer ring; and a bearing seal unit assembled between a small-diameter section at a second end of the boot and a driveshaft by a band and configured to prevent inflow of foreign substances while restricting rotation of the boot.

An outer surface of the outer part of the outer ring may be inserted and fixed in an inner surface of the outer race.

An ABS sensor may be fixed at the outer part of the outer ring; and the inner part of the outer ring may be integrally inserted in the large-diameter section of the boot.

An outer surface of the inner part of the outer ring may be inserted in an inner surface of the large-diameter section of the boot; and the band may be fastened in a structure surrounding the large-diameter section of the boot, whereby the boot may be fastened to the outer ring.

The bearing seal unit may include: a shaft bearing assembled between the small-diameter section of the boot and the driveshaft; and a shaft seal assembled between the small-diameter section of the boot and the driveshaft at a position closer to an end of the small-diameter section of the boot than the shaft bearing.

A bearing housing may be forcibly assembled on an inner surface of the small-diameter section of the boot in a shape surrounding the shaft bearing and the shaft seal; and a boundary step may be formed on an inner surface of the bearing housing at a boundary to the shaft bearing facing the shaft seal.

A seal supporting portion bending radially inward may be formed at an end of the bearing housing; and an outer surface of the shaft seal may be formed in a shape surrounding the seal supporting portion.

An inclined surface of which the outer diameter gradually increases may be formed on an outer surface of the driveshaft that corresponds to the end position of the small-diameter section of the boot; a housing supporting portion bending toward the inclined surface may be formed on an inner surface of the end of the small-diameter section of the boot; and a foreign substance block portion may protrude from an end of the housing supporting portion at a predetermined distance from the inclined surface.

A bearing housing may be forcibly assembled on an inner surface of the small-diameter section of the boot in a shape surrounding the shaft bearing and the shaft seal; and a boundary step may be formed on an inner surface of the bearing housing at a boundary between the shaft bearing and the shaft seal.

A housing supporting portion bending radially inward may be formed at the end of the small diameter-section of the boot; and a seal supporting portion extending radially inward may be formed at an end of the bearing housing that faces the housing supporting portion, whereby the seal supporting portion may be supported on an inner surface of the housing supporting portion.

A maze forming portion bending toward the housing supporting portion may be formed on an inner surface of the seal supporting portion; and a foreign substance block portion protruding radially inward may be formed on the inner surface of the housing supporting portion, so the foreign substance block portion may be formed in a shape covering the maze forming portion.

Anti-slip protrusions may be formed on an inner surface of the boot in which the bearing housing is forcibly fitted.

The boot assembly may include a first grease seal disposed between the outer ring and the inner race of the wheel bearing.

The first grease seal may be assembled in a shape surrounding the end of the outer part of the outer ring and may have a rib portion protruding radially inward and being in contact with the inner race of the wheel bearing.

The boot assembly may include a second grease seal disposed between the outer ring and the wheel housing.

The second grease seal may be assembled in a shape surrounding a middle portion of the outer ring and may have a rib portion protruding toward the wheel housing and being in contact with an end of the wheel housing.

### Advantageous Effects

According to the configuration of the present disclosure described above, instead of the bearing inner seal for sealing between the outer race and the inner race of the wheel bearing, the outer race is covered with the outer ring in the present disclosure, thereby preventing inflow of foreign substances. Accordingly, there is an effect that drag torque due to sealing by the bearing inner seal is reduced, whereby fuel efficiency of a vehicle is improved.

Further, since the boot is not rotated, the action of continuous circumferential folding and unfolding of wrinkles of the boot does not occur in various driving situations including full turning, whereby there is also an effect that friction noise that may be generated by contact and separation of wrinkled portions during driving is prevented.

### DESCRIPTION OF DRAWINGS

FIG. 1 is a cross-sectional view showing a boot assembly of a drive axle according to the present disclosure.

FIG. 2 is an enlarged view showing the portion ‘A’ of FIG. 1.

FIG. 3 is a view exemplifying another structure in which the boot and an outer ring according to the present disclosure are fastened by a band.

FIG. 4 is a view showing the cross-sectional shape of a bearing seal unit according to a first embodiment of the present disclosure.

FIG. 5 is a view illustrating a configuration that prevents inflow of foreign substances at the portion ‘B’ of FIG. 4.

FIG. 6 is a view showing the cross-sectional shape of a bearing seal unit according to a second embodiment of the present disclosure.

FIG. 7 is an enlarged view showing the bearing housing and a small-diameter section of the boot shown in FIG. 6.

FIG. 8 is a view showing the structure of anti-slip protrusions formed on the inner surface of the boot according to the present disclosure.

FIG. 9 is a view showing a structure to which a grease seal according to the present disclosure has been applied.

### EMBODIMENTS

In the following description, the structural or functional description specified to exemplary embodiments according to the concept of the present disclosure is intended to describe the exemplary embodiments, so it should be understood that the present disclosure may be variously embodied, without being limited to the exemplary embodiments.

Embodiments described herein may be changed in various ways and various shapes, so specific embodiments are shown in the drawings and will be described in detail in this specification. However, it should be understood that the exemplary embodiments according to the concept of the present disclosure are not limited to the embodiments which will be described hereinbelow with reference to the accompanying drawings, but all modifications, equivalents, and substitutions are included in the scope and spirit of the present disclosure.

It will be understood that, although the terms first, second, etc. may be used herein to describe various elements, these elements should not be limited by these terms. These terms are only used to distinguish one element, from another element. For instance, a first element discussed below could be termed a second element without departing from the right range of the present disclosure. Similarly, the second element could also be termed the first element.

It is to be understood that when one element is referred to as being “connected to” or “coupled to” another element, it may be connected directly to or coupled directly to another element or be connected to or coupled to another element with the other element therebetween. On the other hand, it should be understood that when one element is referred to as being “connected directly to” or “coupled directly to” another element, it may be connected to or coupled to another element without the other element therebetween. Further, the terms used herein to describe a relationship between elements, that is, “between”, “directly between”, “adjacent” or “directly adjacent” should be interpreted in the same manner as those described above.

Terms used in the present disclosure are used only in order to describe specific exemplary embodiments rather than limiting the present disclosure. Singular forms are intended to include plural forms unless the context clearly indicates otherwise. It will be further understood that the terms “comprises” or “have” used in this specification specify the presence of stated features, numerals, steps, operations, components, parts, or a combination thereof, but do not preclude the presence or addition of one or more other features, numerals, steps, operations, components, parts, or a combination thereof.

Unless otherwise defined, all terms including technical and scientific terms used herein have the same meanings as commonly understood by those skilled in the art to which the present disclosure belongs. It must be understood that the terms defined by the dictionary are identical with the meanings within the context of the related art, and they should not be ideally or excessively formally defined unless the context clearly dictates otherwise.

Exemplary embodiments of the present disclosure are described hereafter in detail with reference to the accompanying drawings.

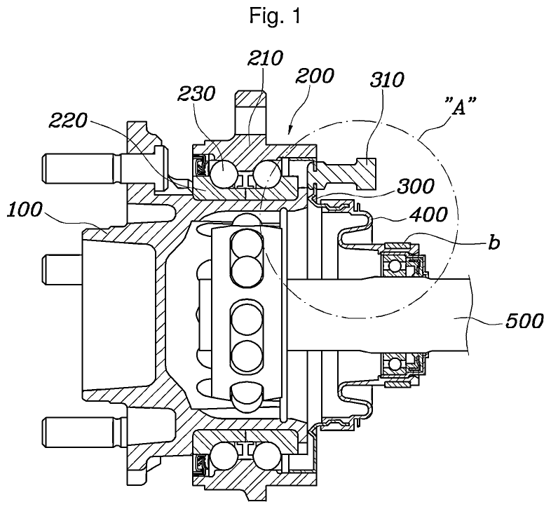

FIG. 1 is a cross-sectional view showing a drive axle assembly according to the present disclosure.

Referring to the figure, a drive axle assembly of the present disclosure is an Integrated Drive Axle (IDA), in which an outer race 210 of a wheel bearing is fixed to a knuckle or a carrier, balls 230 (or rollers) and a cage are assembled between the outer race 21 and the inner race 220 of the wheel bearing 200, and the wheel bearing 200 is inserted in the outer surface of an integrated wheel housing 100.

Further, the end of the wheel housing 100 is rolled up outward by performing orbital forming on the end of the wheel housing 100, so the inner race 220 is fixed to the wheel housing 100 by applying pre-pressure to the wheel bearing 200.

Further, a driveshaft 500 is connected through a constant velocity joint in the wheel housing 100, whereby the power of a powertrain is transmitted to the constant velocity joint through the driveshaft 500 and the constant velocity joint rotates the wheel housing 100 while moving and tilting with movements of a vehicle.

In particular, according to the present disclosure, a boot assembly including a boot 400 is assembled between the outer race 210 of the wheel bearing 200 and the driveshaft 500 with rotation limited.

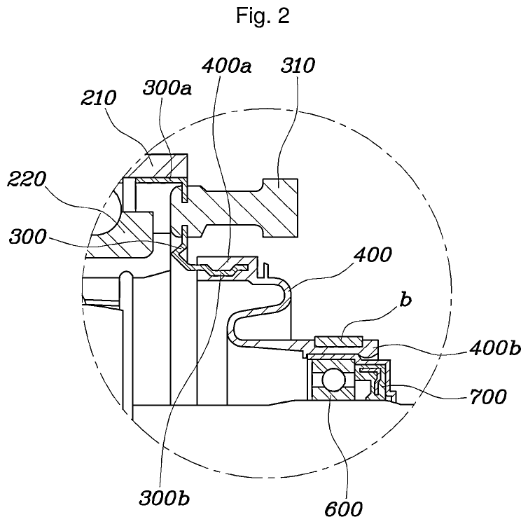

Referring to FIGS. 1 and 2, the present disclosure includes: a wheel bearing 200 assembled to a wheel housing 100; an outer ring 300 formed in a ring shape and having an outer part 300a fixed to an outer race 200 of the wheel bearing 200; a boot 400 having a large-diameter section 400a at a first end assembled to an inner part 300b of the outer ring 300; and a bearing seal unit assembled between a small-diameter section 400b at a second end of the boot 400 and the driveshaft 500 by a band b and preventing inflow of foreign substances while restricting rotation of the boot 400.

For example, the outer ring 300 made of steel is fixed to the large-diameter section 400a of the boot 400 and is coupled to the outer race 210 of the wheel bearing 200.

Further, the bearing seal unit is assembled in a shape surrounding the driveshaft 500 between a small-diameter section 400b of the boot 400 and the driveshaft 500, whereby the driveshaft 500 is allowed to rotate relatively to the boot 400 and the boot 400 is fixed without rotating.

Further, the band b is fastened in a shape surrounding the small-diameter section 400b of the boot 400, whereby the small-diameter section 400b of the boot 400 and the bearing seal unit are fastened by tight fastening force of the band b.

In this way, the portion between the outer race 210 and the inner race 220 of the wheel bearing 200 is covered with the outer ring 300, whereby external foreign substances are prevented from entering the wheel bearing 200, and accordingly, an existing bearing inner seal is removed. Therefore, drag torque due to a bearing inner seal is reduced, and accordingly, fuel efficiency is improved.

Further, since the boot 400 is not rotated even though the constant velocity joint is rotated, the action of continuous circumferential folding and unfolding of wrinkles of the boot 400 does not occur in various driving situations including full turning, whereby friction noise that is generated by contact and separation of wrinkled portions during driving is prevented.

In addition, since the boot 400 and the bearing seal unit are fastened using the band b, assemblability of the boot 400 is improved and workability for replacement and repair is also improved because the boot 400 is easily mounted and detached.

Further, FIG. 2 is an enlarged view showing the portion ‘A’ of FIG. 1.

Referring to the figure, the present disclosure has a structure in which the outer surface of the outer part 300a of the outer ring 300 is inserted in the inner surface of the outer race 210.

That is, since the outer ring 300 is made of steel, the outer part 300a of the outer ring 300 is inserted between the outer race 210 and the inner race 220 and forcibly fitted and fixed in the inner surface of the outer race 210.

Further, an ABS sensor 310 is fixed at the outer part 300a of the outer ring 300 and the inner part 300b of the outer ring 300 is integrally inserted in the large-diameter section 400a of the boot 400.

For example, three parts may be integrated by fixing the ABS sensor 320 to the outer ring 300 and then fixing the outer ring 300 when forming the boot 400.

As another example, three parts may be integrated by fixing the outer ring 300 when forming the boot 400 and then by fixing the ABS sensor 320 to the outer ring 300.

That is, the boot 400 and the ABS sensor 320 are integrated to the outer ring 300, and particularly, the outer ring 300 is directly fixed to the wheel bearing 200, thereby reducing the number of parts constituting the boot assembly and simplifying the structure.

Meanwhile, in the present disclosure, other than the structure in which the inner part 300b of the outer ring 300 is inserted and fixed in the large-diameter section 400a of the boot 400, the inner part 300b of the outer ring 300 may be forcibly fitted and fixed in the inner surface of the large-diameter section 400a of the boot 400.

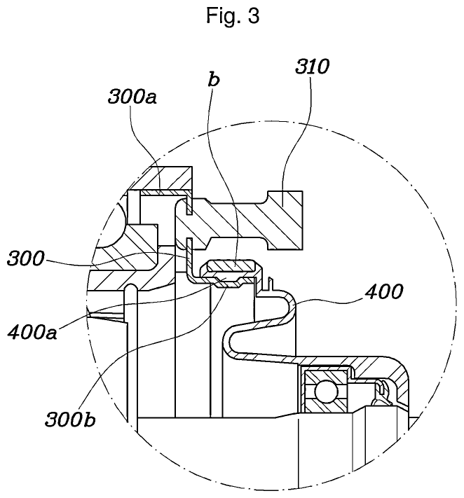

FIG. 3 is a view exemplifying a structure in which the boot 400 and the outer ring 300 according to the present disclosure are fastened by the band b. Referring to the figure, the outer surface of the inner part 300b of the outer ring 300 is inserted in the inner surface of the large-diameter section 400a of the boot 400, and the band b is fastened in a structure surrounding the large-diameter section 400a of the boot 400, whereby the boot 400 can be fastened to the outer ring 300.

That is, the band b is fastened in a shape surrounding the large-diameter section 400a of the boot 400, the large-diameter section 400a of the boot 400 and the inner part 300b of the outer ring 300 are fastened by tight fastening force of the band b.

Accordingly, not only is the assemblability between the boot 400 and the outer ring 300 improved, but the boot 400 is easily mounted and detached, so workability for replacement and repair is improved.

For reference, bands b may be fastened to both of the large-diameter part 400a and the small-diameter part 400b of the boot 400, but workability for replacement and repair can be secured even though only one of two bands b is applied.

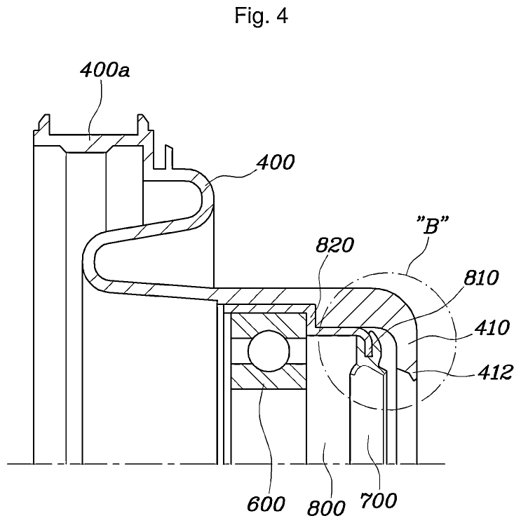

Meanwhile, FIG. 4 is a view showing the cross-sectional shape of a bearing seal unit according to a first embodiment of the present disclosure.

Referring to the figure, the bearing seal unit includes: a shaft bearing 600 assembled between the small-diameter section 400b of the boot 400 and the driveshaft 500; and a shaft seal 700 assembled between the small-diameter section 400b of the boot 400 and the driveshaft 500 at a position closer to the small-diameter section 400b of the boot 400 than the shaft bearing 600.

For example, the shaft bearing 600 may be a bearing such as a ball bearing or a needle bearing, and an inner race 220 of the shaft bearing 600 is supported by the drive shaft 500 and an outer race 210 of the shaft bearing 600 is supported by the small-diameter section 400b of the boot 400.

Further, the shaft seal 700 is installed in a shape surrounding the driveshaft 500 in the end of the small-diameter section 400b of the boot 400, thereby preventing foreign substances from entering the shaft bearing 600 and the boot 400.

However, drag torque is influenced by the shaft seal 700, but the circumference of the shaft seal 700 becomes very shorter than that of the bearing inner seal mounted on the wheel bearing 200 due to the positional characteristic of the shaft seal 700 disposed on the driveshaft 500. Accordingly, the level of increment of drag torque is not large in comparison to the bearing inner seal, so it does not have a bad influence on the fuel efficiency of a vehicle.

Further, as in FIG. 4, a bearing housing 800 is forcibly assembled on the inner surface of the small-diameter section 400b of the boot 400 in a shape surrounding the shaft bearing 600 and the shaft seal 700, and a boundary step 820 may be formed on the inner surface of the bearing housing 800 at the boundary to the shaft bearing 600 facing the shaft seal 700.

For example, the shaft bearing 600 is assembled on the inner surface of the bearing housing 800 positioned at large-diameter section 400a of the boot 400 from the boundary step 820 on the inner surface of the bearing housing 800.

That is, the shaft bearing 600 can be firmly and stably assembled inside the bearing housing 800 by the boundary step 820 formed at the middle portion of the inner surface of the bearing housing 800.

For reference, the shaft bearing 600 and the shaft seal 700 may be forcibly assembled inside the bearing housing 800 and the bearing housing 800 may be integrally assembled to the boot 400.

Further, as in FIG. 4, a seal supporting portion 810 radially bending inward may be formed at an end of the bearing housing 800 and the outer surface of the shaft seal 700 may be formed in a shape surrounding the seal supporting portion 810.

That is, the shaft seal 700 is fixed to the seal supporting portion 810 and a rib portion of the shaft seal 700 is in close contact with the outer surface of the driveshaft 500, thereby preventing foreign substances from entering the shaft bearing 600 through between the driveshaft 500 and the shaft seal 700.

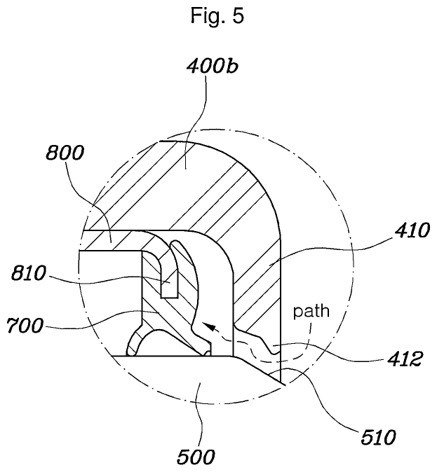

Further, FIG. 5 is a view illustrating a configuration that prevents inflow of foreign substances at the portion ‘B’ of FIG. 4.

Referring to the figure, an inclined surface 510 of which the outer diameter gradually increases may be formed on the outer surface of the driveshaft 500 that corresponds to the end position of the small-diameter section 400b of the boot 400, a housing supporting portion 410 bending toward the inclined surface 510 may be formed on the inner surface of the end of the small-diameter section 400b of the boot 400, and a foreign substance block portion 412 may protrude from the end of the housing supporting portion 410 at a predetermined distance from the inclined surface 510.

That is, when foreign substances enter the gap between the foreign substance block portion 412 and the inclined surface 510, the foreign substances entering the gap meet the inclined surface 510, whereby movement of the foreign substances is obstructed.

Accordingly, external foreign substances entering between the foreign substance block portion 412 and the inclined surface 510 are minimized, and even though foreign substances enter between the housing supporting portion 410 and the shaft seal 700, the foreign substances are prevented from entering the boot 400 by the shaft seal 700, whereby foreign substances are fundamentally prevented from entering the boot 400.

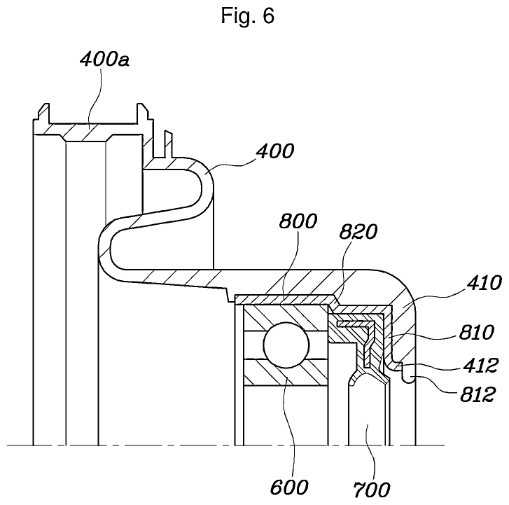

Meanwhile, FIG. 6 is a view showing the cross-sectional shape of a bearing seal unit according to a second embodiment of the present disclosure.

Referring to the figure, a bearing housing 800 is forcibly assembled on the inner surface of the small-diameter section 400b of the boot 400 in a shape surrounding the shaft bearing 600 and the shaft seal 700, and a boundary step 820 may be formed on the inner surface of the bearing housing 800 at the boundary between the shaft bearing 600 and the shaft seal 700.

For example, the shaft bearing 600 is assembled on the inner surface of the bearing housing 800 positioned at large-diameter section 400a of the boot 400 from the boundary step 820 on the inner surface of the bearing housing 800, and the shaft seal 700 is assembled on the inner surface of the outer portion of the bearing housing 800 positioned at the small diameter-section 400b of the boot 400.

That is, the shaft bearing 600 and the shaft seal 700 can be firmly and stably assembled inside the bearing housing 800 by the boundary step 820 formed at the middle portion of the inner surface of the bearing housing 800.

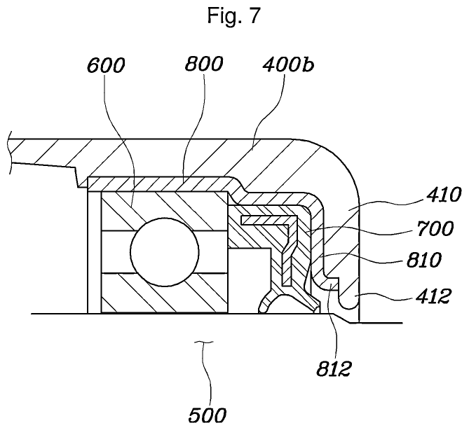

Further, FIG. 7 is an enlarged view showing the bearing housing 800 and the small diameter-section 400b of the boot 400 shown in FIG. 6.

Referring to the figure, a housing supporting portion 410 bending radially inward is formed at the end of the small diameter-section 400b of the boot 400 and a seal supporting portion 810 extending radially inward is formed at the end of the bearing housing 800 that faces the housing supporting portion 410, whereby the seal supporting portion 810 can be supported on the inner surface of the housing supporting portion 410.

That is, the seal supporting portion 810 is in close contact with the inner surface of the housing supporting portion 410, so external foreign substances are prevented from entering the boot 400 through between the small diameter-section 400b of the boot 400 and the bearing housing 800.

Further, a maze forming portion 821 bending toward the housing supporting portion 410 is formed on the inner surface of the seal supporting portion 810, and the foreign substance block portion 412 protruding radially inward is formed on the inner surface of the housing supporting portion 410, so the foreign substance block portion 412 can be formed in a shape covering the maze forming portion 821.

For example, the foreign substance block portion 412 is formed radially inward toward the driveshaft 500 and axially covers the maze forming portion 812.

Accordingly, since maze forming portion 812 is in close contact with the inner surface of the foreign substance block portion 412, even though foreign substances enter the space between the foreign substance block portion 412 and the driveshaft 500, the foreign substances are prevented from entering between the housing supporting portion 410 and the seal supporting portion 810.

Accordingly, not only are external foreign substances prevented from entering the boot 400 through the gap between the small diameter-section 400b of the boot 400 and the bearing housing 800, but foreign substances are prevented from entering the boot 400 by the shaft seal 700.

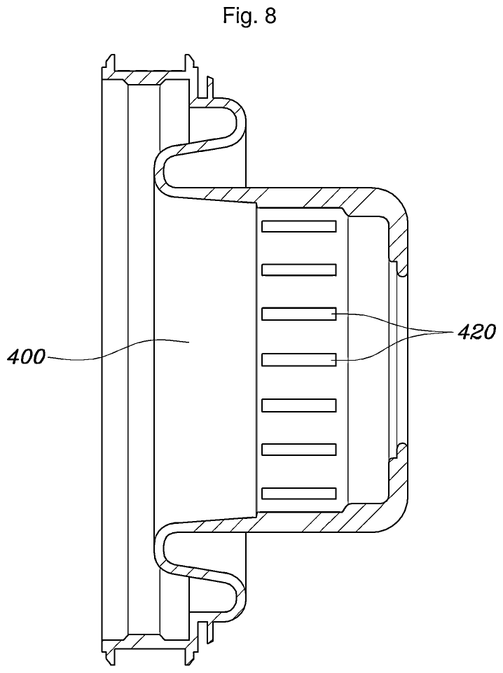

Meanwhile, FIG. 8 is a view showing the structure of anti-slip protrusions 420 formed on the inner surface of the boot 400.

Referring to the figure, anti-slip protrusions 420 may be formed on the inner surface of the boot 400 in which the bearing housing 800 is forcibly fitted.

For example, anti-slip protrusions 420 are formed axially along the inner surface of the boot 400 in which the bearing housing 800 is forcibly fitted, so slipping of the bearing housing 800 forcibly fitted in the boot 400 is prevented.

In this configuration, a sealing agent is applied between the inner surface of the boot 400 and the outer surface of the bearing housing 800, whereby assemblability of the boot 400 and the bearing housing 800 is improved, and accordingly, slipping of the bearing housing 800 is more securely prevented.

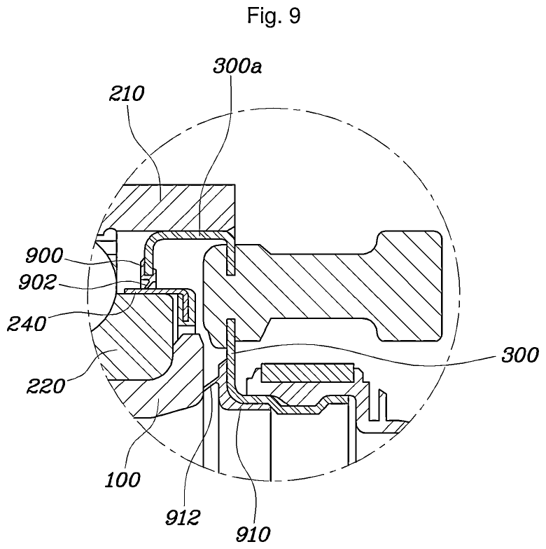

Meanwhile, FIG. 9 is a view showing a structure to which a grease seal according to the present disclosure has been applied, and the grease seal may be divided into a first grease seal 900 and a second grease seal 910.

Referring to the figure, the present disclosure includes a first grease seal 900 disposed between the outer ring 300 and the inner race 220 of the wheel bearing 200.

In detail, the first grease seal 900 is assembled in a shape surrounding the end of the outer part 300a of the outer ring 300 and may have a rib portion 902 protruding radially inward and being in contact with the inner race 220 of the wheel bearing 200.

However, the present disclosure shows a structure in which an encoder ring 240 is assembled in a shape covering a portion of the outer surface of the inner race 220, and in this structure, the rib portion 902 of the first grease seal 900 is in contact with the encoder ring 240.

That is, leakage of grease for a wheel bearing in the wheel bearing 200 is prevented by the first grease seal 900, so mixing of the grease for a wheel bearing and grease for a constant velocity joint in the wheel housing 100 is prevented.

Further, the present disclosure includes a second grease seal 910 disposed between the outer ring 300 and the wheel housing 100.

In detail, the second grease seal 910 is assembled in a shape covering the middle portion of the outer ring 300 and may have a rib portion 912 protruding toward the wheel housing 100 and being in contact with the end of the wheel housing 100.

For example, the rib portion 912 of the second grease seal 910 is in contact with an orbital-formed end of the wheel housing 100.

That is, leakage of grease for a wheel bearing in the wheel bearing 200 is prevented by the first grease seal 900, so mixing of the grease for a wheel bearing and grease for a constant velocity joint in the wheel housing 100 is prevented.

Accordingly, only any one of the first grease seal 900 and the second grease seal 910 may be provided in the present disclosure.

That is, the first grease seal 900 is for preventing leakage of the grease for a wheel bearing and the second grease seal 910 is for preventing leakage of the grease for a constant velocity joint, so even though only one of the first grease seal 900 and the second grease seal 910 is provided, mixing of the grease for a wheel bearing and the grease for a constant velocity joint is prevented.

As described above, instead of the bearing inner seal for sealing between the outer race 210 and the inner race 220 of the wheel bearing 200, the outer race 210 is covered with the outer ring 300 in the present disclosure, thereby preventing inflow of foreign substances. Accordingly, drag torque due to sealing by the bearing inner seal is reduced, whereby fuel efficiency of a vehicle is improved.

Further, since the boot 400 is not rotated, the action of continuous circumferential folding and unfolding of wrinkles of the boot 400 does not occur in various driving situations including full turning, whereby friction noise that may be generated by contact and separation of wrinkled portions during driving is prevented.

Although the present disclosure was described with reference to the detailed embodiments, it is apparent to those skilled in the art that the present disclosure may be changed and modified in various ways without the scope of the present disclosure and it should be noted that the changes and modifications are included in claims.

### DESCRIPTION OF REFERENCE NUMERALS

100: wheel housing
200: wheel bearing
210: outer race
220: inner race
230: ball
300: outer ring
300a: outer part
300b: inner part
310: ABS sensor
400: boot
400a: large-diameter section
400b: small-diameter section
410: housing supporting portion
412: foreign substance block portion
420: anti-slip protrusion
500: driveshaft
510: inclined surface
600: shaft bearing
700: shaft seal
800: bearing housing
810: seal supporting portion
812: maze forming portion
820: boundary step
900: first grease seal
902: rib portion
910: second grease seal
912: rib portion
b: band

1. A boot assembly of a drive axle, comprising:
a wheel bearing assembled to a wheel housing;
an outer ring formed in a ring shape and having an outer part fixed to an outer race of the wheel bearing;
a boot having a large-diameter section at a first end assembled to an inner part of the outer ring; and
a bearing seal unit assembled between a small-diameter section at a second end of the boot and a driveshaft by a band and configured to prevent inflow of foreign substances while restricting rotation of the boot.

2. The boot assembly of claim 1, wherein an outer surface of the outer part of the outer ring is inserted and fixed in an inner surface of the outer race.

3. The boot assembly of claim 1, wherein an ABS sensor is fixed at the outer part of the outer ring; and
the inner part of the outer ring is integrally inserted in the large-diameter section of the boot.

4. The boot assembly of claim 1, wherein an outer surface of the inner part of the outer ring is inserted in an inner surface of the large-diameter section of the boot; and
the band is fastened in a structure surrounding the large-diameter section of the boot, whereby the boot is fastened to the outer ring.

5. The boot assembly of claim 1, wherein the bearing seal unit includes:
a shaft bearing assembled between the small-diameter section of the boot and the driveshaft; and
a shaft seal assembled between the small-diameter section of the boot and the driveshaft at a position closer to an end of the small-diameter section of the boot than the shaft bearing.

6. The boot assembly of claim 5, wherein a bearing housing is forcibly assembled on an inner surface of the small-diameter section of the boot in a shape surrounding the shaft bearing and the shaft seal; and
a boundary step is formed on an inner surface of the bearing housing at a boundary to the shaft bearing facing the shaft seal.

7. The boot assembly of claim 5, wherein a seal supporting portion bending radially inward is formed at an end of the bearing housing; and
an outer surface of the shaft seal is formed in a shape surrounding the seal supporting portion.

8. The boot assembly of claim 5, wherein an inclined surface of which the outer diameter gradually increases is formed on an outer surface of the driveshaft that corresponds to the end position of the small-diameter section of the boot;
a housing supporting portion bending toward the inclined surface is formed on an inner surface of the end of the small-diameter section of the boot; and
a foreign substance block portion protrudes from an end of the housing supporting portion at a predetermined distance from the inclined surface.

9. The boot assembly of claim 5, wherein a bearing housing is forcibly assembled on an inner surface of the small-diameter section of the boot in a shape surrounding the shaft bearing and the shaft seal; and
a boundary step is formed on an inner surface of the bearing housing at a boundary between the shaft bearing and the shaft seal.

10. The boot assembly of claim 5, wherein a housing supporting portion bending radially inward is formed at the end of the small diameter-section of the boot; and
a seal supporting portion extending radially inward is formed at an end of the bearing housing that faces the housing supporting portion, whereby the seal supporting portion is supported on an inner surface of the housing supporting portion.

11. The boot assembly of claim 10, wherein a maze forming portion bending toward the housing supporting portion is formed on an inner surface of the seal supporting portion; and
a foreign substance block portion protruding radially inward is formed on the inner surface of the housing supporting portion, so the foreign substance block portion is formed in a shape covering the maze forming portion.

12. The boot assembly of claim 6, wherein anti-slip protrusions are formed on an inner surface of the boot in which the bearing housing is forcibly fitted.

13. The boot assembly of claim 1, comprising a first grease seal disposed between the outer ring and the inner race of the wheel bearing.

14. The boot assembly of claim 13, wherein the first grease seal is assembled in a shape surrounding the end of the outer part of the outer ring and has a rib portion protruding radially inward and being in contact with the inner race of the wheel bearing.

15. The boot assembly of claim 1, comprising a second grease seal disposed between the outer ring and the wheel housing.

16. The boot assembly of claim 15, wherein the second grease seal is assembled in a shape surrounding a middle portion of the outer ring and has a rib portion protruding toward the wheel housing and being in contact with an end of the wheel housing.

17. The boot assembly of claim 9, wherein anti-slip protrusions are formed on an inner surface of the boot in which the bearing housing is forcibly fitted.
